(19) United States
(12) Patent Application Publication
(10) Pub. No.: US 2016/0004798 A1
(43) Pub. Date: Jan. 7, 2016

(54) DETERMINING THE PERFORMANCE OF AN ENVIRONMENTAL SYSTEM USING A PREDICTIVE MODEL

(71) Applicant: Ingersoll-Rand Company, Davidson, NC (US)

(72) Inventors: Roy R. Crawford, Tyler, TX (US); Wayne N. Kraft, Tyler, TX (US); Mark E. Groskreutz, Tyler, TX (US); Franklin K. Rolles, Denver, NC (US)

(73) Assignee: Ingersoll-Rand Company, Davidson, NC (US)

(21) Appl. No.: 14/755,939

(22) Filed: Jun. 30, 2015

Related U.S. Application Data
(60) Provisional application No. 62/021,535, filed on Jul. 7, 2014.

(51) Int. Cl. G06F 17/50; G06Q 10/06; G06Q 50/06; G06Q 30/02

(52) U.S. Cl. CPC G06F 17/5009; G06Q 30/0234; G06Q 30/0215; G06Q 10/067; G06Q 50/06

(57) ABSTRACT

Disclosed herein are systems and methods for predicting an energy savings resulting from the replacement of existing equipment with new equipment. In the example embodiments, the energy saving prediction is utilized to create a customized warranty for an individual customer of an HVAC system or subcomponent thereof. Historical energy usage, historical climate data, old and new equipment parameters, and customer use data is input to a predictive modeling algorithm, which determines an energy savings prediction. Alternative models may be employed and a weighting factor applied to each to arrive at an improved energy savings prediction. The energy savings prediction is utilized to warranty to the customer an estimated dollar savings that will result from the installation of the new equipment. The warranty provides that, in the event the predicted energy savings is not realized, the customer is entitled to receive a dollar amount representing the shortfall in warranted energy savings.

### CROSS-REFERENCE TO RELATED APPLICATION

This application claims the benefit of and priority to U.S. Provisional Application Ser. No. 62/021,535 entitled “DETERMINING THE PERFORMANCE OF AN ENVIRONMENTAL SYSTEM USING A PREDICTIVE MODEL” filed Jul. 7, 2014, the entirety of which is hereby incorporated by reference herein for all purposes.

### BACKGROUND

1. Technical Field

The present disclosure is directed to systems and methods for determining the performance of an energy-consuming system using a predictive model, and more particularly, to the creation of customer-specific warranty terms based at least in part upon the application of a predictive model to customer usage data, historical environmental data, and equipment data.

2. Background of Related Art

Increased energy efficiency and reduced energy costs are common goals shared by many throughout the world. These goals may be achieved by modifying use patterns, such as by car-pooling to work, or by lowering a thermostat in the winter and wearing warmer clothes inside the home. In other instances, these goals can be achieved by replacing older equipment with newer, more efficient equipment. For example, an older, heavier automobile may be replaced with a lighter and more efficient model, or a residential heat pump system having a single speed motor may be replaced with a newer high-efficiency model having a variable speed motor.

Various government programs have been implemented to educate consumers and businesses about the energy efficiency of various products and to encourage the purchase of such products, such as the Car Allowance Rebate System (“Cash for Clunkers” program) promoted by the U.S. Department of Transportation and the Energy Star® program promoted by the U.S. Environmental Protection Agency. In addition, various incentives, such as tax rebates and government subsidies, have been offered to persuade consumers to invest in new, energy-efficient equipment.

Such incentive programs can have drawbacks, because consumers may be unwilling to replace existing equipment which, while not providing state-of-the-art energy efficiency, may otherwise be fully functional and have considerable service life remaining. In other instances, consumers may be skeptical about actually realizing the energy and cost savings promised as a result of purchasing the new equipment and consequently, are reluctant to make a purchase.

### SUMMARY

In one aspect, the present disclosure is directed to a computer-implemented method for predicting an efficiency improvement in an environmental system where a first device is replaced by a second device. The method includes receiving, at a processor, first energy usage data corresponding to a first time period in which the first device is included in the environmental system. The method includes receiving, at a processor, a first efficiency rating corresponding to the first device and a second efficiency rating corresponding to the second device. The method includes receiving, at a processor, climate data corresponding to the first time period and applying, by a processor, a predictive model to the first energy usage data, the first efficiency rating, the second efficiency rating, and the climate data to determine an efficiency improvement resulting from the replacement of the first device by the second device.

In some embodiments, the method includes receiving second energy usage data corresponding to a second time period in which the second device is included in the environmental system, and comparing the first energy usage data to the second energy usage data to determine whether the efficiency improvement was realized. In some embodiments, the predictive model determines a first energy savings prediction based upon a utility energy savings model; determines a second energy savings prediction based upon a linear energy savings model; and applies a weighting factor to the first energy savings prediction and the second energy savings prediction to determine the efficiency improvement. In some embodiments, a hedge factor is applied to the efficiency improvement.

In some embodiments, the method includes delivering, to a customer, a warranty document expressing the predicted efficiency improvement as a predicted cost savings. In some embodiments, the method includes determining whether the predicted cost savings was realized; and delivering a payment to the customer if the predicted cost savings was not realized. In some embodiments, the payment is calculated based upon the difference between the predicted cost savings and the actual cost savings. In some embodiments, the payment is tendered in a form selected from the group consisting of an electronic funds transfer to a customer bank account, an electronic funds transfer to a customer credit card account, an electronic funds transfer to a customer utility account, a gift card, a check, and currency.

In another aspect, the present disclosure is directed to a system for predicting an efficiency improvement in an environmental system where a first environmental system device is replaced by a second environmental system device. The system includes a user device, a processor communicatively couplable to the user device, and non-volatile memory operatively coupled with the processor. The non-volatile memory includes a set of executable instructions, which, when executed by the processor, cause the processor to receive first energy usage data corresponding to a first time period in which the first environmental device is included in the environmental system; receive a first efficiency rating corresponding to the first environmental device; receive a second efficiency rating corresponding to the second environmental device; receive climate data corresponding to the first time period; and apply a predictive model to the first energy usage data, the first efficiency rating, the second efficiency rating, and the climate data to determine an efficiency improvement resulting from the replacement of the first environmental device by the second environmental device.

In some embodiments of the system, the non-volatile memory further includes executable instructions, which, when executed by the processor, cause the processor to receive second energy usage data corresponding to a second time period in which the second environmental device is included in the environmental system; and compare the first energy usage data to the second energy usage data to determine whether the efficiency improvement was realized. In some embodiments of the system, the non-volatile memory further includes executable instructions, which, when executed by the processor, cause the processor to determine a first energy savings prediction based upon a utility energy savings model; determine a second energy savings prediction based upon a linear energy savings model; and apply a weighting factor to the first energy savings prediction and the second energy savings prediction to determine the efficiency improvement. In some embodiments of the system, the non-volatile memory further includes executable instructions, which, when executed by the processor, cause the processor to apply a hedge factor to the efficiency improvement. In some embodiments of the system, the non-volatile memory further includes executable instructions, which, when executed by the processor, cause the processor to transmit a document expressing the predicted efficiency improvement as a predicted cost savings. In some embodiments of the system, the non-volatile memory further includes executable instructions, which, when executed by the processor, cause the processor to determine whether the predicted cost savings was realized; and cause to be delivered to the customer a payment if the predicted cost savings was not realized.

In some embodiments of the system, the payment is calculated based upon the difference between the predicted cost savings and the actual cost savings. In some embodiments of the system, the payment is delivered in a form selected from the group consisting of an electronic funds transfer to a customer bank account, an electronic funds transfer to a customer credit card account, an electronic funds transfer to a customer utility account, a gift card, a check, and currency.

In yet another aspect, the present disclosure is directed to non-volatile computer readable media storing a set of executable instructions to predict an efficiency improvement in an environmental system where a first device is replaced by a second device. The stored set of executable instructions, when executed by a processor, cause the processor to receive first energy usage data corresponding to a first time period in which the first environmental device is included in the environmental system; receive a first efficiency rating corresponding to the first environmental device; receive a second efficiency rating corresponding to the second environmental device; receive climate data corresponding to the first time period; and apply a predictive model to the first energy usage data, the first efficiency rating, the second efficiency rating, and the climate data to determine an efficiency improvement resulting from the replacement of the first environmental device by the second environmental device.

In some embodiments, the non-volatile computer readable media stores executable instructions, which, when executed by the processor, further cause the processor to receive second energy usage data corresponding to a second time period in which the second environmental device is included in the environmental system; and compare the first energy usage data to the second energy usage data to determine whether the efficiency improvement was realized. In some embodiments, the non-volatile computer readable media stores executable instructions, which, when executed by the processor, further cause the processor to determine a first energy savings prediction based upon a utility energy savings model; determine a second energy savings prediction based upon a linear energy savings model; and apply a weighting factor to the first energy savings prediction and the second energy savings prediction to determine the efficiency improvement. In some embodiments, the non-volatile computer readable media stores executable instructions, which, when executed by the processor, further cause the processor to transmit a document expressing the predicted efficiency improvement as a predicted cost savings.

### BRIEF DESCRIPTION OF THE DRAWINGS

Various embodiments of the disclosed system and method are described herein with reference to the drawings wherein:

FIG. 1 is a block diagram of a system for the creation, evaluation, and administration of customer-specific warranties in accordance with an embodiment of the present disclosure;

FIG. 2 is a block diagram of a system for the creation, evaluation, and administration of customer-specific warranties in accordance with an embodiment of the present disclosure;

FIGS. 3A and 3B are a data flow diagrams illustrating the evaluation of expected performance of an environmental system using a predictive model in accordance with embodiments of the present disclosure;

FIG. 4 is a data flow diagram illustrating the evaluation of the actual performance of environmental system in accordance with an embodiment of the present disclosure;

FIG. 5 is a flowchart illustrating a predictive model in accordance with an embodiment of the present disclosure;

FIG. 6 is a flowchart illustrating an embodiment of an utility model energy savings calculation in accordance with an embodiment of the present disclosure; and

FIG. 7 is a flowchart illustrating an embodiment of a linear model energy savings calculation in accordance with an embodiment of the present disclosure.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure may be described herein in terms of functional block components, code listings, optional selections, page displays, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, assembler, PERL, Python, PHP, Ruby, or the like, with the various algorithms being implemented with any combination of data structures, objects, processes, routines or other programming elements. The object code created may be executed by any device, on a variety of operating systems, including without limitation Apple OSX®, Apple iOS®, Google Android®, HP WebOS®, Linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including without limitation hard disks, optical storage devices (e.g., CD-ROM, DVD-ROM, BD-ROM), magnetic storage devices, semiconductor storage devices (e.g., flash memory, USB thumb drives, SSD devices) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented.

The disclosed systems and/or methods may be embodied, at least in part, in application software that may be downloaded, in whole or in part, from either a website or an application store (e.g., “app store”, “play store”) to the mobile device. In another embodiment, the disclosed system and method may be included in the mobile device firmware, hardware, and/or software.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

Disclosed herein are systems and methods for determining an energy savings prediction resulting from the replacement of existing equipment with new equipment. Example embodiments are presented herein which relate to the replacement of environmental systems, e.g., heating, ventilation, and air conditioning (HVAC) systems, however, it should be understood that the present disclosure is not limited to any one type of equipment, device, or instrumentality, nor is the present disclosure limited to any one particular form of energy consumption. For example, embodiments in accordance with the present disclosure may be employed with natural gas powered furnaces, water heaters, and the like; or any other type of energy-consuming device now or in the future known. The disclosed systems and methods may be advantageously utilized where, by way of non-limiting examples, the new equipment is of higher efficiency than the equipment it replaces, or where the new equipment is of different capacity than the existing equipment.

Embodiments of the systems and methods disclosed herein may also be utilized for selecting an initial purchase of new equipment wherein a comparison is made between two (or more) new products having different efficiency ratings. For example, a new homeowner may be offered a choice between a “builders” HVAC system having a lower efficiency rating and an “upgrade” HVAC system having a higher efficiency rating. In these embodiments, an energy saving prediction of the savings realized by the selection of the “upgrade” system is determined.

In the example embodiments, the energy saving prediction is utilized to create a customized warranty for an individual customer of an HVAC system or subcomponent (e.g., heat pump, compressor, evaporator, thermostat, and the like). In one such embodiment, a base electric rate is established with reference to the homeowner's location and utility provider (e.g., $0.12/kWh) which, with the energy savings prediction, is utilized to warranty to the customer an estimated dollar savings that will result from the installation of the new equipment and/or selection of higher-efficiency equipment. In the present example embodiment, the warranty provides that, in the event the predicted energy savings is not realized, the customer is entitled to receive a dollar amount representing the shortfall in energy savings, calculated at a previously-established base electric rate. In some embodiments, other forms of warranty coverage may include, without limitation, a customer being entitled to receive a dollar amount representing the shortfall in energy savings, calculated at the actual electric rate(s) used to compute the homeowner's electric bill and/or a stated dollar amount (e.g., sum certain) warranty benefit.

A customer profile is created to establish a baseline for the predictive model. The customer profile includes historical energy usage data (e.g., past twelve months of the customer's utility bills), existing equipment data (e.g., make, model, capacity, and efficiency rating of a customer's existing HVAC system), historical local climate data (e.g., past twelve months of degree-day, temperature, humidity and/or other climatological data for the customer's location), and general identification and contact information for the customer including name, address, telephone numbers, email address(es), login information (username, password), payment information (bank account, credit card, ACH/EFT information, PayPal® account, and the like). In addition, new equipment data (e.g., make, model, capacity, and efficiency rating of the to-be-installed HVAC system) is included in the customer profile. The customer profile is provided to the predictive model, which, in turn, determines the expected efficiency improvement of the new HVAC system over the existing one.

In some embodiments, a customer profile may be generated at least in part based upon a group of other similarly-situated customers. In one non-limiting example, a neighborhood of similarly-constructed homes that share a common climatological history may be used to generate a baseline or generic customer profile applicable to premises in the neighborhood, or to comparable neighborhoods in the area.

Additional customer profile data may include, without limitation, the location of the property, year of construction of the structure, square footage, number of stories, number of occupants, type and number of major energy-consuming products, and whether on-site power generating equipment is installed. The seasonal energy efficiency ratio (SEER), energy efficiency ratio (EER), and/or the heat seasonal performance factor (HSPF) of the existing and/or new equipment may additionally or alternatively be included in the customer profile.

In some embodiments, a prequalification is performed to ensure the accuracy of the predictive model. Prequalification criteria may dictate that the use pattern of the equipment to be replaced, or of the premises in general, did not significantly change over the course of the historical baseline period. For example, and without limitation, the criteria to be enforced may require that customer's installation site be a single family home used as the customer's primary residence; that the customer provide twelve months of electric utility bills (showing the baseline year energy usage in kWh); that the customer has not experienced any significant changes in electric use within the past twelve months caused by, for example and without limitation, adding a pool, hot tub, spa, tanning bed, major appliances, an electric vehicle charging station, changing the number of people residing in the home, performing major renovations, adding or finishing space, or adding on-site power generation such as solar, wind, and the like; that the customer is replacing an existing system with a capacity of at least two tons; is replacing a low-efficiency system that is less than or equal to 12 SEER with a high-efficiency system which is, for example, at least 5 SEER higher than the existing system, and/or that the new installation includes a connected thermostat (e.g., a thermostat capable of communicating operational data to a remote device via, e.g., the Internet). In some embodiments, other suitable periods of time for providing historical energy use (e.g., periods greater than, or less than, twelve months may be utilized). In some embodiments, prequalification criteria may be overcome or waived by incorporating energy usage estimates corresponding to the significantly-changed elements of the premises into the energy prediction, and/or providing a usage allowance for the new elements, additional occupants, etc.

In embodiments, the predictive model evaluates the historical utility data (e.g., the customer's twelve month-prior electric usage) in view of the historical climate data (e.g., local degree-days) to determine the base load of the customer's residence, e.g., the underlying usage pattern of the particular customer under evaluation. The predictive model then calculates, for each of the existing and the new equipment, an energy usage based upon the product of a scaling factor, the base load, the mean degree-days, the seer rating of the existing/new equipment, and the HVAC unit capacity. The difference in energy usage between the existing and new equipment is determined, and the predictive model outputs the predicted energy savings. In turn, the product of the predicted energy savings and the base electric rate is used to establish the warranty terms, e.g., the warranted costs savings to the consumer. In embodiments, the scaling factor may be utilized to hedge the warranted energy savings, that is, to lower the expected savings by a predetermined factor to reduce the incidence of warranty claims where the predicted energy savings may be overly-optimistic. In some embodiments, the predictive model may additionally or alternatively determine the predicted energy saving based on heating, cooling, and base load estimates derived from curve fitting of historical climate data and historical energy consumption data.

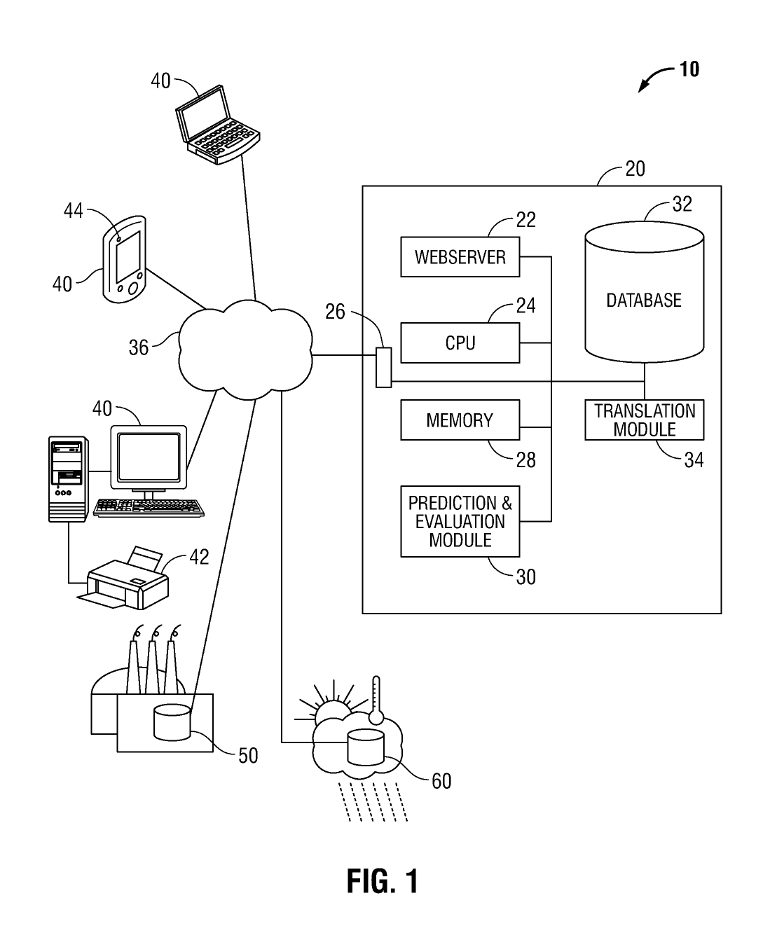

With reference to FIG. 1, an embodiment of an energy saving prediction and customized warranty system 10 is presented. The system includes a computer 20 having, in operable communication, a processor 24, a memory 28, a webserver module 22, a predictive/evaluation module 30, a translation module 34, and a database 32. Computer 20 is communicatively coupled to a data network 36 via a communications interface 26. Communications interface 26 may provide any suitable type of data communications, including without limitation wired Ethernet® communication, wireless 802.11 (“WiFi”) communication, wireless Bluetooth® communication, fiber optic, or other communications interface now or in the future known. Data network 36 may include any public or private LAN or WAN, such as without limitation the public Internet.

One or more user devices 40 are communicatively coupled to computer 20 via network 36, and may include, without limitation, a notebook computer, mobile device (e.g., “smartphone”), a tablet computer, and/or a desktop computer. One or more user device 40 may include a printer 42 for memorializing documents in physical form (e.g., printed to paper). One or more user device 40 may include an optical input device 44, such as a still or video camera, which may be utilized to perform optical character recognition (OCR) of human-readable text and/or to perform scanning of one- and two-dimensional barcodes.

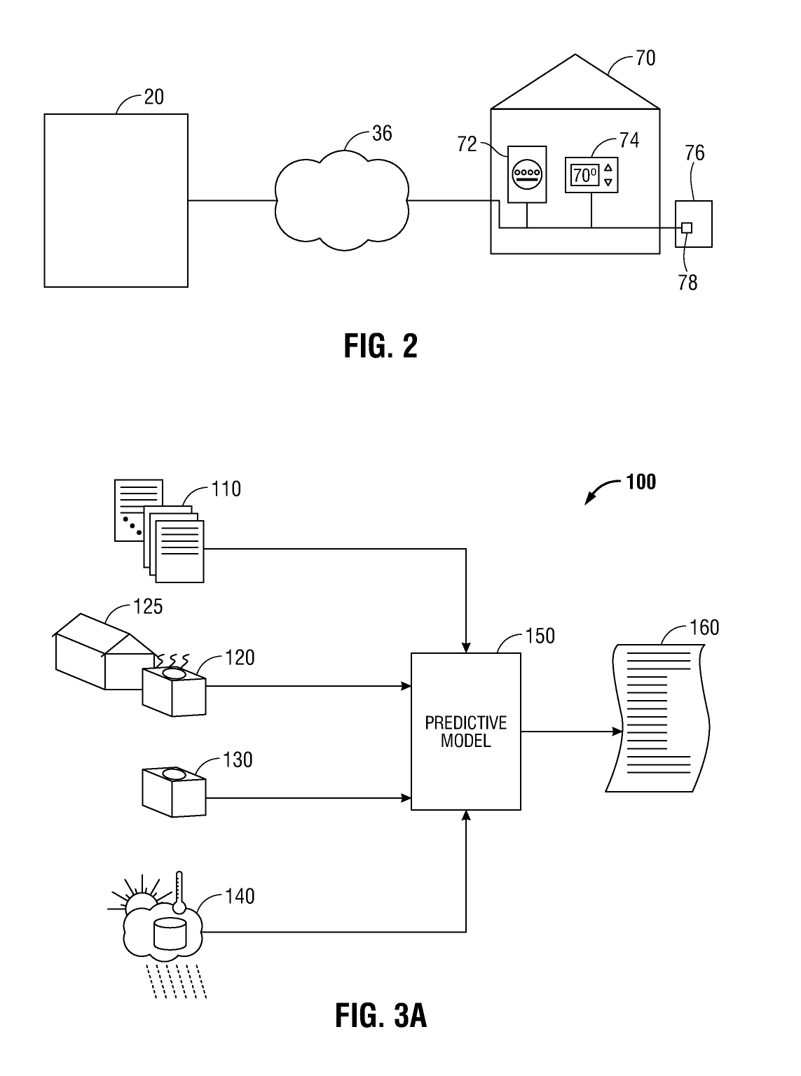

A utility database 50 is communicatively coupled to computer 20. Utility database 50 includes energy usage data (e.g., electric utility billing and consumption data and/or real-time log of data usage) for the customer premises, which is communicated to computer 20 via network 36. A climate database 60 is communicatively coupled to computer 20, and includes historical climate data relating to the locale of the customer's residence 70 (FIG. 2).

Turning to FIG. 2, computer 20 is in operative communication with one or more devices situated at the customer's residence 70. In the present example embodiment, computer 20 is in operative communication with electric meter 72 (e.g., a “smart meter”), a connected thermostat 74, and/or an energy monitoring device 78 included with HVAC unit 76. Electric meter 72, a connected thermostat 74, and/or energy monitoring device 78 are configured to communicate operational data respectively associated therewith to a remote device, e.g., computer 20 and/or to predictive/evaluation module 30. The communicated operational data may provide one or more input parameters to a predictive model, an energy savings calculation, and/or an energy use evaluation as described herein.

Computer 20 includes translation module 34. Translation module 34 includes a set of programmed instructions which, when executed by processor 24, performs reformatting, conversion and/or decryption of data received from one or more external sources, such as utility database 50, climate database 60, electric meter 72, connected thermostat 74, and/or energy monitoring device 78, into a form suitable for use generally with system 10. For example, and without limitation, data received from utility database 50 may arrive in an electronic data interchange (EDI) format having a strictly-defined record oriented format unsuitable for use by database 32. In another non-limiting example, data received from connected thermostat 74 may arrive in eXtended Markup Language (XML) format. In still another non-limiting example, data received from connected thermostat 74 and/or utility database 50 may arrive in JavaScript Object Notation (JSON) format. In yet another non-limiting example, data received from electric meter 72 may arrive in encrypted form. Translation module 34 converts incoming data into suitable form for use by the system 10.

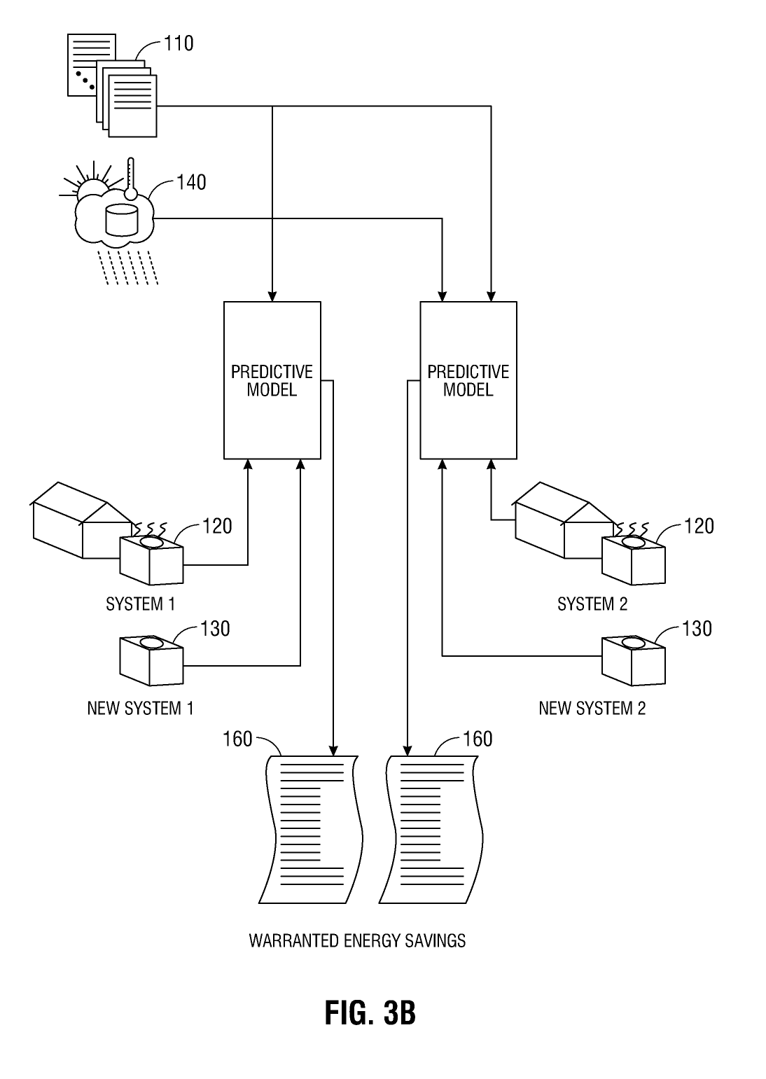

FIG. 3 illustrates a predictive model data flow diagram 100 according to an embodiment of the present disclosure. Historical usage data 110 includes energy usage history for the subject customer representing the previous twelve months usage. In some embodiments, the energy history may include more than, or less than, twelve month's worth of data. An energy cost structure may additionally be included with historical usage data 110, and may include a cost per kWh, a delivery charge (fixed or per kWh-based), a fuel surcharge, a tiered pricing arrangement (e.g., having price breaks or increases based upon increments of consumption), and the like. Historical usage data 110 may be entered into the predictive model 150 manually, e.g., by the customer entering data from a year's worth of the customer's utility bills via a webpage form provided by webserver 22 to user device 40, and/or or may be downloaded from the utility database 50 provided by the customer's electric utility.

Existing equipment data 120 includes data relating to the currently-existing equipment installed at a customer's residence (e.g., make, model, SEER/EER/HSPF and capacity of the existing HVAC unit). Property data 125 includes data relating particularly to the customer's residence, such as, without limitation, a location of the property, a year of construction of the structure, a square footage of the structure, a construction type of the structure (e.g., wood frame, brick, etc.), a number of stories of the structure, the number of occupants, the type and number of major energy-consuming products, and whether on-site power generating equipment is installed and the nature thereof. Typically, existing equipment data 120 and/or property data 125 is entered via a webpage form provided by webserver 22 and presented on user device 40, although it is envisioned that existing equipment data 120 and/or property data 125 may be downloaded in full or in part where such data is held in an accessible database, such as a municipal records (town clerk) database. In embodiments, a user need only manually enter a model number, serial number, or other identifying indicia of the existing equipment, and the remaining existing equipment data 120 (SEER/EER/HSPF, capacity, etc.) may be downloaded from an available database included in database 32 and/or remotely accessed via network 36.

New equipment data 130 includes data relating to the new equipment slated to be installed at the customer's residence (e.g., make, model, SEER/EER/HSPF and capacity of the new HVAC unit). Typically, a user need only manually enter a model number, serial number, or other identifying indicia of the new equipment, and the remaining information (SEER/EER/HSPF, capacity, etc.) may be downloaded from an available database included in database 32 and/or remotely accessed via network 36.

Historical climate data 140 includes historical climate data relating to the locale of the customer's residence, and may include, without limitation, daily temperatures, average temperatures, degree-days, humidity, rainfall, pollen counts, cloud cover, and so forth. In embodiments, a user enters indicia of locale (e.g., postal code, latitude/longitude, town name, etc.) and the historical climate data 140 is downloaded from climate database 60. The time period represented by the historical climate data 140 corresponds to the time period represented by the historical usage data 110, e.g., typically the most recent twelve month period.

One or more predictive models may be employed. In some embodiments, a utility predictive model is employed which curve fits actual (historical) monthly energy use (e.g., kWh) for residence 70 to the monthly degree days (cooling degree days CDD and/or heating degree days HDD) historical pattern to calculate three coefficients for base load, cooling load, and heating load of residence 70. The three coefficients are applied to the existing and new HVAC efficiency ratings (e.g., SEER or HSPF) to predict HVAC energy use (kWh), as described in detail below. Advantageously, the utility model considers the energy use pattern of the subject residence 70 when formulating the energy savings prediction.

In some embodiments, a linear predictive model is employed where a linear relationship between degree days (CDD or HDD) and the HVAC equipment size (e.g., tonnage) and efficiency ratings (e.g., SEER or HSPF) is employed to predict HVAC energy use (kWh). The approach is advantageous, for example, where utility history may be unavailable or unreliable, as it uses fixed coefficients (slopes) in the linear formulas for terms other than degree days, tonnage, and efficiency ratings.

In some embodiments, both a utility model and a linear predictive model are employed. In these embodiments, a weighting factor is utilized to rationalize or proportion the contribution of each model to the final energy savings prediction. For example, in a scenario where the historical utility data is lacking, the linear model would be weighted more heavily, perhaps up to 100%, than the calibrated utility model. As historical data becomes available, the weighting factor may be adjusted to introduce a greater influence by the calibrated utility model to the prediction result, and, ideally, provide a more accurate prediction. The weighting factor may be adjusted based upon other factors, including, without limitation, regional climate, homogeneity of building construction, and/or past performance of the calibrated utility model and the linear predictive model in a particular market.

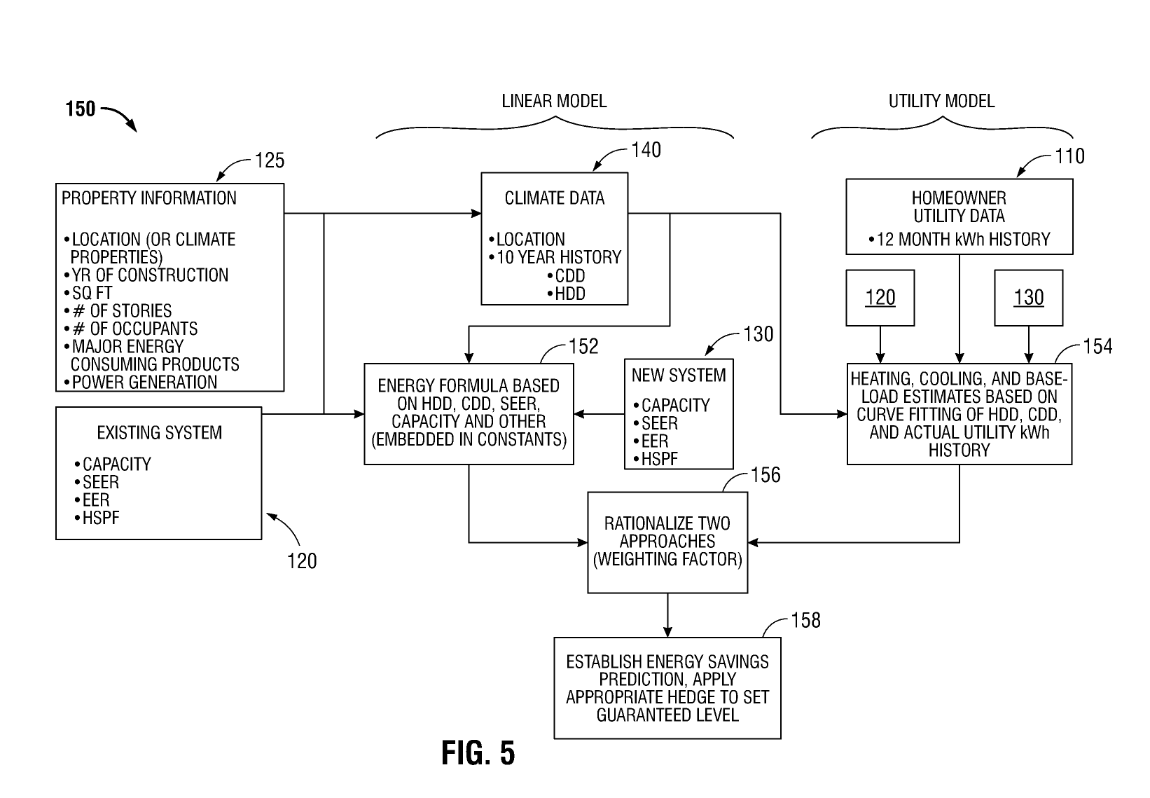

The historical usage data 110, existing equipment data 120, property data 125, new equipment data 130, and historical climate data 140 are processed by predictive model 150. As seen in embodiment exemplified in FIG. 5, a predictive model 150 determines an first energy savings prediction 152 based upon an energy formula taking into account the historical heating degree days, cooling degree days, the comparative energy efficiencies of the existing and new HVAC systems (e.g., SEER, EER, and/or HSPF), and one or more scaling factors. Predictive model 150 determines a second energy savings prediction 154 based on heating degree day, cooling degree day, and base load estimates derived from curve fitting of historical climate data 140 and historical energy consumption data 110. The first energy savings prediction 152 and second energy savings prediction 154 are proportioned at 156 to establish a final energy savings prediction 158. In embodiments, a hedge factor or cap may be applied to the final energy saving prediction to set the warranted energy savings 160. For example, in embodiments, the warranted energy savings 160 may be capped, to set a maximum limit on the amount of energy savings and/or recoupment available to the customer. In some embodiments, the hedge factor may be applied to reduce the warranted savings by a cushion to account for a margin of error, for example, by 20%, or by a fixed dollar amount, e.g., decreased by $50.00. In some embodiments, the hedge factor may be applied to increase the warranted savings by percentage or by a fixed dollar amount.

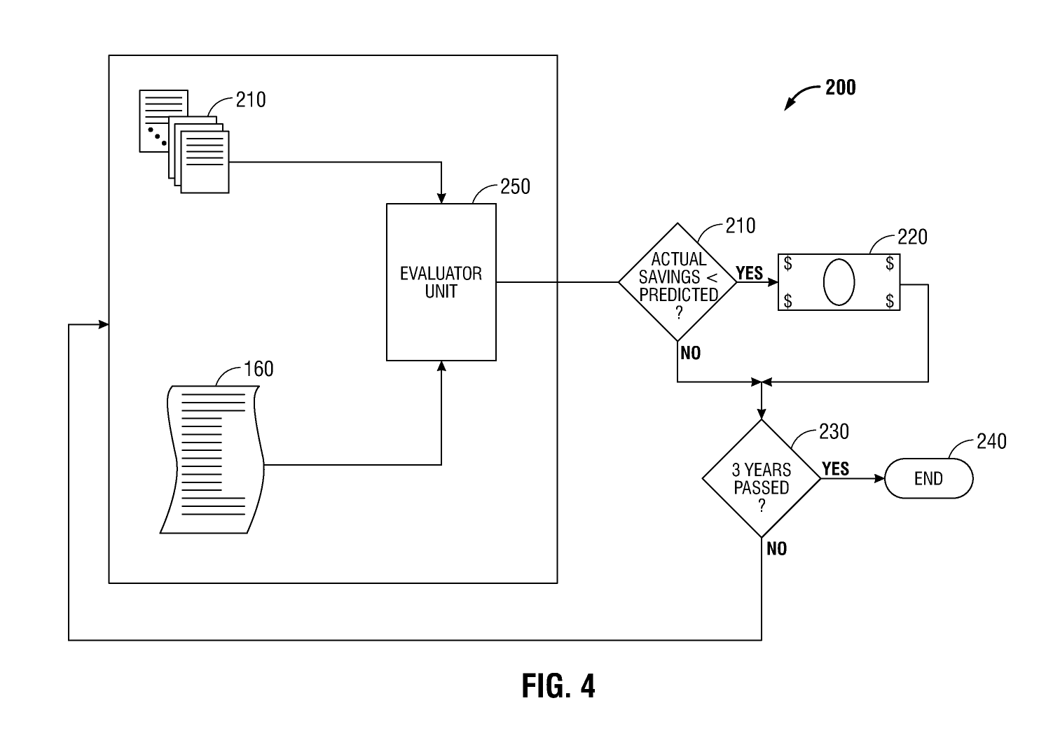

With reference to FIG. 4, aspects of an embodiment of a warranty performance evaluation 200 in accordance with the present disclosure are illustrated. In the present example embodiment, the warranted energy savings 160 provides that, as evaluated on an annual basis for three years after the installation of the new equipment, that the new equipment will deliver the warranted energy savings. In the event the new equipment does not deliver the warranted energy savings, e.g., that the actual energy consumption at the customer's premises does not decrease as promised, the customer will receive a payment representing the cost difference between the promised savings and the actual (higher) usage. After the passing of a year's time (“year one”) from the installation of the new equipment, the year one historical usage data 210 and the warranted energy savings 160 are provided to the evaluator unit 250. In some embodiments, the year one historical usage data 210 is provided by the customer by entering data from a year's worth of the customer's utility bills via a webpage form provided by webserver 22 to user device 40. In some embodiments, the year one data 210 is downloaded from the utility database 50 provided by the customer's electric utility. In yet other embodiments, the customer may provide authentication credentials via a webpage form provided by webserver 22 to user device 40, whereupon a transfer of the customer's year one data is initiated from utility database 50 to database 32 and/or evaluator unit 250. In still other embodiments, the year one data 210 is received at least in part from electric meter 72, connected thermostat 74, and/or energy monitoring device 78.

Evaluator unit 250 then evaluates the actual energy use which is compared to the previous energy use to determine the actual energy savings, if any. If, in the comparison performed at 210, it is determined that the actual energy savings is less than the warranted energy savings 160, then a payment 200 is initiated to the customer representing the savings shortfall. In some embodiments, an electronic payment, such as without limitation, an automated clearinghouse (ACH), electronic funds transfer (EFT), a credit or debit card credit transaction, or a PayPal® payment is initiated. In some embodiments, an EFT transaction may apply a credit to the customer's utility account. In yet other embodiments, the customer may receive cash, a check, prepaid debit card, or gift card in satisfaction of the savings shortfall.

In embodiments, for each annual period thereafter, up to the warranted period (which in the present embodiment is three years), the evaluation is repeated to determine whether, for each annual period (e.g., “year two” and “year three”), the actual savings met or exceeded the warranted energy savings 160. In embodiments, the evaluation is performed on a cumulative basis, e.g., energy savings for the first year, energy saving for the first and second year combined, and so forth. After the expiration of the warranty period at 230, no further evaluation cycles are performed, and the warranty is expired (240). It should be appreciated that the various example warranty terms described herein, e.g., duration of warranty and other warranty terms, are presented for illustrative purposes and in no way intended to limit other embodiments in accordance with the present disclosure. In some embodiments, in the event the predicted saving are not realized (e.g., when actual usages exceed the prediction model) a report or warning may be issued to enable an analyst to determine the reasons for the shortfall and to modify and/or correct the predictive model as appropriate.

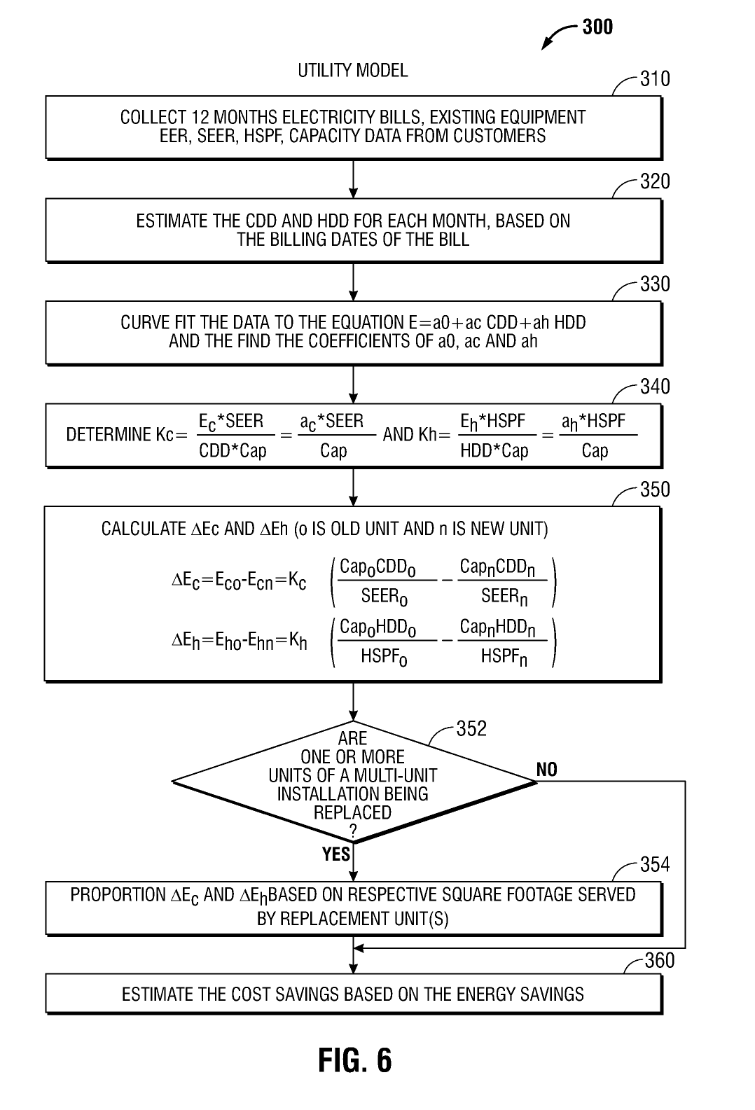

Referring now to FIG. 6, a flowchart representing an embodiment of a calibrated utility predictive model 300 for energy savings prediction in accordance with the present disclosure is presented. In the step 310, energy usage data is collected. Data representing the prior year's energy consumption for the subject premises is collected. Additionally, data relating to the existing equipment, such as, without limitation, an efficiency rating (e.g., EER, SEER, HSPF) and a capacity rating (BTU, tonnage, etc.) are collected. In the step 320, the cooling degree days (CDD) and/or heating degree days (HDD) is determined for each month (which may be a calendar month or a billing cycle month) of the prior year. The CDD/HDD may be estimated from energy usage data (e.g., from the electric bill) and/or may be determined with reference to historical climatological data. In the step 330, the energy usage data is curve fit to the equation E=a0+ac CDD+ah HDD to determine the coefficients a0, ac, and ah.

In the step 340, a cooling constant Kc and a heating constant Kh are determined in accordance with the equations:

$$Kc = \frac{{E}_{c} * SEER}{CDD * Cap} = \frac{{a}_{c} * SEER}{Cap} and$$

$$Kh = \frac{{E}_{h} * HSPF}{HDD * Cap} = \frac{{a}_{h} * HSPF}{Cap}$$

In the step 350, the cooling and heating energy savings, e.g., the change in cooling energy (ΔEc) and in heating energy (ΔEh), is determined in accordance with the equations:

$$Δ {E}_{c} = {E}_{co} - {E}_{cn} = {K}_{c} ( \frac{{Cap}_{o} {CDD}_{o}}{{SEER}_{o}} - \frac{{Cap}_{n} {CDD}_{n}}{{SEER}_{n}} )$$

$$Δ {E}_{h} = {E}_{ho} - {E}_{hn} = {K}_{h} ( \frac{{Cap}_{o} {HDD}_{o}}{{HSPF}_{o}} - \frac{{Cap}_{n} {HDD}_{n}}{{HSPF}_{n}} )$$

where o represents old equipment parameters, n represents new equipment parameters and Cap represents the capacity rating of the respective equipment. In the step 360, the cost savings is determined by multiplying the total energy savings (ΔE_{c}+ΔEₕ) by the base energy rate (e.g., a predetermined electric rate or an actual electric rate). The resultant cost savings is then incorporated into the terms of the energy savings warranty as described herein. Thus the utility model savings may be expressed as:

UtilitySavingsₑₛₜ=(ΔE_{c}+ΔEₕ)* Cost_Per_kWh

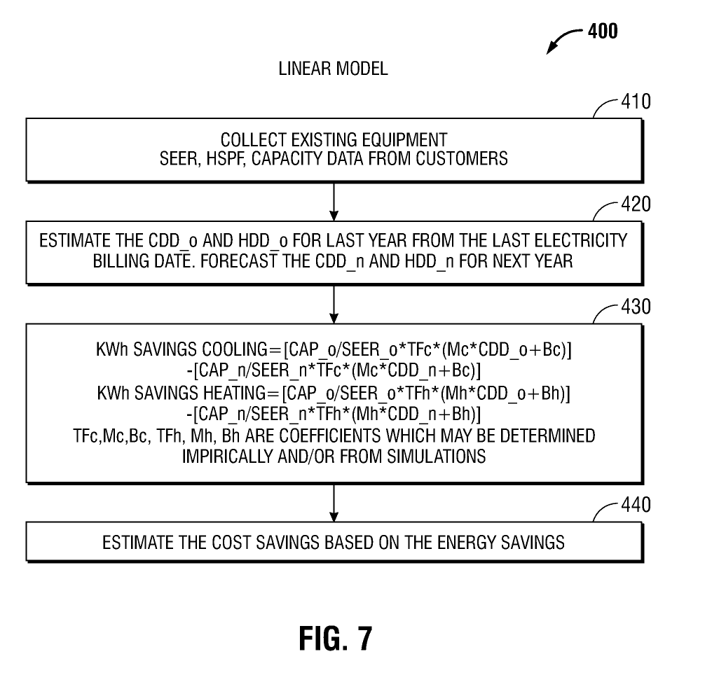

Turning to FIG. 7, a flowchart representing an embodiment of a linear predictive model 400 for energy savings prediction in accordance with the present disclosure is presented. In step 410, data from the existing equipment is received, including SEER/HSPF, and capacity (tonnage) of the existing equipment. In step 420, the cumulative CDD and/or HDD for the prior year are determined. In embodiments the cumulative CDD and/or HDD are tabulated from the earliest utility billing date within the previous twelve month period. The estimated cumulative CDD and/or HDD for the next twelve month period are also determined. In embodiments, next year's estimated CDD and/or HDD is based upon a five year annual running average of actual, historical CDD and/or HDD for the customer's location.

In step 430, the cooling mode (in the case of A/C and heat pump installations) and/or heating mode (heat pump-only installations) savings is computed in accordance with the equation:

kWh_Savings_Cooling=[min(TONₑ, TONₙ)/max(SEERₑ, 9) * TF_{c} * (M_{c} * CDD_{LastYear}+B_{c})]−[TONₙ/SEERₙ * TF_{c} * (M_{c} * CDD_{Avg5Y}+B_{c})]

where TON, is the nominal (name plate) tonnage of the existing outdoor unit; TONₙ is the nominal tonnage of the new outdoor unit; SEERₑ is the estimated SEER of the existing equipment, adjusted for nominal to actual SEER and age degradation; SEERₙ is the specified SEER of the new equipment; TF_{c} is an equipment factor used to adjust typical nominal cooling tonnage to actual capacity, e.g., for package units (one piece units) TF_{c}=97% whereas for split systems, TF_{c}=96%; CDD_{LastYear} is the sum of the last 12 months of CDD data for the particular location (at the point in time the guarantee is made); CDD_{AVg5Y} is the 5 year annual running average of actual CDD; M_{c} is a linear slope constant for cooling, typically M_{c}=5.8, however M_{c} may be adjusted for regional climate variations; and where B_{c} represents the y-intercept of the linear cooling formula (typically zero).

For heating mode of heat pump systems, the heating mode savings is computed in accordance with the equation:

kWh_Savings_Heating=[TONₑ/HSPFₑ * TFₕ * (Mₕ * HDD_{LastYear})+Bₕ]−[TONₙ/HSPFₙ * TFₕ * (Mₕ * HDD_{Avg5Y})+Bₕ]
where HSPFₑ is the estimated HSPF of the existing equipment, adjusted for nominal to actual SEER and age degradation; HSPFₙ is the nominal HSPF of the new equipment; TFₕ is an equipment factor used to adjust typical nominal heating tonnage to actual capacity for use in the formula (e.g., for package units TFₕ=93%, for split units TFₕ=94%); HDD_{LastYear} is the sum of the last 12 months of HDD data for the particular location (at the point in time the guarantee is made); HDD_{AVg5Y} is the 5 year annual running average of actual HDD; Mₕ is a linear slope constant for heating, typically Mₕ=4.5, however this may be adjusted for regional climate variations; and where Bₕ is the y-intercept of the linear heating formula (typically zero).

In step 440 the linear model estimated cost savings is determined based on the product of the total energy savings and the unit cost of energy (base energy rate). In an embodiment the estimated cost savings is computed in accordance with the equation:

LinearSavingsₑₛₜ=(kWh_Savings_Cooling+kWh_Savings_Heating)* Cost_Per_kWh

UtilitySavingsₑₛₜ and LinearSavingsₑₛₜ may then be used, either individually, or combined in a rationalized proportion as defined by the weighting factor, to determine the cost savings, which is then incorporated into the terms of the energy savings warranty as described herein.

### Aspects

It is noted that any of aspects 1-8, 9-16, and 17-20 below can be combined with each other in any combination.

Aspect 1. A computer-implemented method for predicting an efficiency improvement in an environmental system wherein a first device is replaced by a second device, comprising receiving, at a processor, first energy usage data corresponding to a first time period in which the first device is included in the environmental system; receiving, at a processor, a first efficiency rating corresponding to the first device; receiving, at a processor, a second efficiency rating corresponding to the second device; receiving, at a processor, climate data corresponding to the first time period; and applying, by a processor, a predictive model to the first energy usage data, the first efficiency rating, the second efficiency rating, and the climate data to determine an efficiency improvement resulting from the replacement of the first device by the second device.

Aspect 2. The method in accordance with aspect 1, further comprising receiving second energy usage data corresponding to a second time period in which the second device is included in the environmental system; and comparing the first energy usage data to the second energy usage data to determine whether the efficiency improvement was realized.

Aspect 3. The method in accordance with any of aspects 1-2, wherein the predictive model determines a first energy savings prediction based upon a utility energy savings model; determines a second energy savings prediction based upon a linear energy savings model; and applies a weighting factor to the first energy savings prediction and the second energy savings prediction to determine the efficiency improvement.

Aspect 4. The method in accordance with any of aspects 1-3, further comprising applying a hedge factor to the efficiency improvement.

Aspect 5. The method in accordance with any of aspects 1-4, further comprising delivering, to a customer, a warranty document expressing the predicted efficiency improvement as a predicted cost savings.

Aspect 6. The method in accordance with any of aspects 1-5, further comprising determining whether the predicted cost savings was realized; and delivering a payment to the customer if the predicted cost savings was not realized.

Aspect 7. The method in accordance with any of aspects 1-6, wherein the payment is calculated based upon the difference between the predicted cost savings and the actual cost savings.

Aspect 8. The method in accordance with any of aspects 1-7, wherein the payment is tendered in a form selected from the group consisting of an electronic funds transfer to a customer bank account, an electronic funds transfer to a customer credit card account, an electronic funds transfer to a customer utility account, a gift card, a check, and currency.

Aspect 9. A system for predicting an efficiency improvement in an environmental system wherein a first environmental system device is replaced by a second environmental system device, comprising a user device; a processor communicatively couplable to the user device; and non-volatile memory operatively coupled with the processor and including a set of executable instructions, which, when executed by the processor, cause the processor to receive first energy usage data corresponding to a first time period in which the first environmental device is included in the environmental system; receive a first efficiency rating corresponding to the first environmental device; receive a second efficiency rating corresponding to the second environmental device; receive climate data corresponding to the first time period; and apply a predictive model to the first energy usage data, the first efficiency rating, the second efficiency rating, and the climate data to determine an efficiency improvement resulting from the replacement of the first environmental device by the second environmental device.

Aspect 10. The system in accordance with aspect 9, wherein the set of executable instructions, which, when executed by the processor, further cause the processor to receive second energy usage data corresponding to a second time period in which the second environmental device is included in the environmental system; and compare the first energy usage data to the second energy usage data to determine whether the efficiency improvement was realized.

Aspect 11. The system in accordance with any of aspects 9-10, wherein the set of executable instructions, which, when executed by the processor, further cause the processor to determine a first energy savings prediction based upon a utility energy savings model; determine a second energy savings prediction based upon a linear energy savings model; and apply a weighting factor to the first energy savings prediction and the second energy savings prediction to determine the efficiency improvement.

Aspect 12. The system in accordance with any of aspects 9-11, wherein the set of executable instructions, which, when executed by the processor, further cause the processor to apply a hedge factor to the efficiency improvement.

Aspect 13. The system in accordance with any of aspects 9-12, wherein the set of executable instructions, which, when executed by the processor, further cause the processor to transmit a document expressing the predicted efficiency improvement as a predicted cost savings.

Aspect 14. The system in accordance with any of aspects 9-13, wherein the set of executable instructions, which, when executed by the processor, further cause the processor to determine whether the predicted cost savings was realized; and cause to be delivered to the customer a payment if the predicted cost savings was not realized.

Aspect 15. The system in accordance with any of aspects 9-14, wherein the payment is calculated based upon the difference between the predicted cost savings and the actual cost savings.

Aspect 16. The system in accordance with any of aspects 9-15, wherein the payment is delivered in a form selected from the group consisting of an electronic funds transfer to a customer bank account, an electronic funds transfer to a customer credit card account, an electronic funds transfer to a customer utility account, a gift card, a check, and currency.

Aspect 17. Non-volatile computer readable media storing a set of executable instructions to predict an efficiency improvement in an environmental system wherein a first device is replaced by a second device, which, when executed by a processor, cause the processor to receive first energy usage data corresponding to a first time period in which the first environmental device is included in the environmental system; receive a first efficiency rating corresponding to the first environmental device; receive a second efficiency rating corresponding to the second environmental device; receive climate data corresponding to the first time period; and apply a predictive model to the first energy usage data, the first efficiency rating, the second efficiency rating, and the climate data to determine an efficiency improvement resulting from the replacement of the first environmental device by the second environmental device.

Aspect 18. The non-volatile computer readable media in accordance with aspect 17, wherein the set of executable instructions, which, when executed by the processor, further cause the processor to receive second energy usage data corresponding to a second time period in which the second environmental device is included in the environmental system; and compare the first energy usage data to the second energy usage data to determine whether the efficiency improvement was realized.

Aspect 19. The non-volatile computer readable media in accordance with any of aspects 17-18, wherein the set of executable instructions, which, when executed by the processor, further cause the processor to determine a first energy savings prediction based upon a utility energy savings model; determine a second energy savings prediction based upon a linear energy savings model; and apply a weighting factor to the first energy savings prediction and the second energy savings prediction to determine the efficiency improvement.

Aspect 20. The non-volatile computer readable media in accordance with any of aspects 17-19, wherein the set of executable instructions, which, when executed by the processor, further cause the processor to transmit a document expressing the predicted efficiency improvement as a predicted cost savings.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A computer-implemented method for predicting an efficiency improvement in an environmental system wherein a first device is replaced by a second device, comprising:
receiving, at a processor, first energy usage data corresponding to a first time period in which the first device is included in the environmental system;
receiving, at a processor, a first efficiency rating corresponding to the first device;
receiving, at a processor, a second efficiency rating corresponding to the second device;
receiving, at a processor, climate data corresponding to the first time period; and
applying, by a processor, a predictive model to the first energy usage data, the first efficiency rating, the second efficiency rating, and the climate data to determine an efficiency improvement resulting from the replacement of the first device by the second device.

2. The method in accordance with claim 1, further comprising:
receiving second energy usage data corresponding to a second time period in which the second device is included in the environmental system; and
comparing the first energy usage data to the second energy usage data to determine whether the efficiency improvement was realized.

3. The method in accordance with claim 1, wherein the predictive model:
determines a first energy savings prediction based upon a utility energy savings model;
determines a second energy savings prediction based upon a linear energy savings model; and
applies a weighting factor to the first energy savings prediction and the second energy savings prediction to determine the efficiency improvement.

4. The method in accordance with claim 1, further comprising applying a hedge factor to the efficiency improvement.

5. The method in accordance with claim 1, further comprising delivering, to a customer, a warranty document expressing the predicted efficiency improvement as a predicted cost savings.

6. The method in accordance with claim 5, further comprising:
determining whether the predicted cost savings was realized; and
delivering a payment to the customer if the predicted cost savings was not realized.

7. The method in accordance with claim 6, wherein the payment is calculated based upon the difference between the predicted cost savings and the actual cost savings.

8. The method in accordance with claim 6, wherein the payment is tendered in a form selected from the group consisting of an electronic funds transfer to a customer bank account, an electronic funds transfer to a customer credit card account, an electronic funds transfer to a customer utility account, a gift card, a check, and currency.

9. A system for predicting an efficiency improvement in an environmental system wherein a first environmental system device is replaced by a second environmental system device, comprising:
a user device;
a processor communicatively couplable to the user device; and
non-volatile memory operatively coupled with the processor and including a set of executable instructions, which, when executed by the processor, cause the processor to:
receive first energy usage data corresponding to a first time period in which the first environmental device is included in the environmental system;
receive a first efficiency rating corresponding to the first environmental device;
receive a second efficiency rating corresponding to the second environmental device;
receive climate data corresponding to the first time period; and
apply a predictive model to the first energy usage data, the first efficiency rating, the second efficiency rating, and the climate data to determine an efficiency improvement resulting from the replacement of the first environmental device by the second environmental device.

10. The system in accordance with claim 9, wherein the set of executable instructions, which, when executed by the processor, further cause the processor to:
receive second energy usage data corresponding to a second time period in which the second environmental device is included in the environmental system; and
compare the first energy usage data to the second energy usage data to determine whether the efficiency improvement was realized.

11. The system in accordance with claim 9, wherein the set of executable instructions, which, when executed by the processor, further cause the processor to:
determine a first energy savings prediction based upon a utility energy savings model;
determine a second energy savings prediction based upon a linear energy savings model; and
apply a weighting factor to the first energy savings prediction and the second energy savings prediction to determine the efficiency improvement.

12. The system in accordance with claim 9, wherein the set of executable instructions, which, when executed by the processor, further cause the processor to apply a hedge factor to the efficiency improvement.

13. The system in accordance with claim 9, wherein the set of executable instructions, which, when executed by the processor, further cause the processor to transmit a document expressing the predicted efficiency improvement as a predicted cost savings.

14. The system in accordance with claim 13, wherein the set of executable instructions, which, when executed by the processor, further cause the processor to:
determine whether the predicted cost savings was realized; and
cause to be delivered to the customer a payment if the predicted cost savings was not realized.

15. The system in accordance with claim 14, wherein the payment is calculated based upon the difference between the predicted cost savings and the actual cost savings.

16. The system in accordance with claim 14, wherein the payment is delivered in a form selected from the group consisting of an electronic funds transfer to a customer bank account, an electronic funds transfer to a customer credit card account, an electronic funds transfer to a customer utility account, a gift card, a check, and currency.

17. Non-volatile computer readable media storing a set of executable instructions to predict an efficiency improvement in an environmental system wherein a first device is replaced by a second device, which, when executed by a processor, cause the processor to:
receive first energy usage data corresponding to a first time period in which the first environmental device is included in the environmental system;
receive a first efficiency rating corresponding to the first environmental device;
receive a second efficiency rating corresponding to the second environmental device;
receive climate data corresponding to the first time period; and
apply a predictive model to the first energy usage data, the first efficiency rating, the second efficiency rating, and the climate data to determine an efficiency improvement resulting from the replacement of the first environmental device by the second environmental device.

18. The non-volatile computer readable media in accordance with claim 17, wherein the set of executable instructions, which, when executed by the processor, further cause the processor to:
receive second energy usage data corresponding to a second time period in which the second environmental device is included in the environmental system; and
compare the first energy usage data to the second energy usage data to determine whether the efficiency improvement was realized.

19. The non-volatile computer readable media in accordance with claim 17, wherein the set of executable instructions, which, when executed by the processor, further cause the processor to:
determine a first energy savings prediction based upon a utility energy savings model;
determine a second energy savings prediction based upon a linear energy savings model; and
apply a weighting factor to the first energy savings prediction and the second energy savings prediction to determine the efficiency improvement.

20. The non-volatile computer readable media in accordance with claim 17, wherein the set of executable instructions, which, when executed by the processor, further cause the processor to transmit a document expressing the predicted efficiency improvement as a predicted cost savings.
